(19) United States
(12) Patent Application Publication
(10) Pub. No.: US 2008/0123869 A1
(43) Pub. Date: May 29, 2008

(54) Broadcasting device having power frequency carrier

(75) Inventor: Yuan-Yu Huang, Taipei City (TW)

Correspondence Address: TROXELL LAW OFFICE PLLC, 5205 LEESBURG PIKE, SUITE 1404, FALLS CHURCH, VA, 22041, US

(73) Assignee: HANSDER ENGINEERING CO., LTD, Taipei City (TW)

(21) Appl. No.: 11/594,237

(22) Filed: Nov. 8, 2006

(30) Foreign Application Priority Data
Nov. 11, 2005 (TW) 094219521

(51) Int. Cl. H04R 27/00

(52) U.S. Cl. 381/82

(57) ABSTRACT

The present invention receives a voice signal from an input device; then the voice signal is processed through an amplifier; and, then, the voice signal is transmitted along an indoor electrical power line with power frequency carrier to be heard by using speakers.

### FIELD OF THE INVENTION

The present invention relates to a broadcasting device; more particularly, relates to inputting a voice signal to an input device to be transmitted to an output device a long an indoor electrical power by using an amplifying device coordinated with a first and a second power frequency carrier device.

### DESCRIPTION OF THE RELATED ART

A general amplifying device 6 (as shown in FIG. 5) comprises an amplifier 61; a microphone unit 62 connected with the amplifier 61 for receiving a voice signal; and at least a speaker unit 63 connected with the amplifier 61 to sound the voice signal received by the microphone unit 62. The amplifier 61 connects to each speaker unit 63 respectively with a signal transmission line 7; and the amplifier 61 comprises a power line 64 to obtain an outside power source. By the above structure, the voice signal is transmitted along the signal transmission line 7 by using the amplifying device 6. The speaker unit 63 is shut by removing or blocking the signal transmission line 7 between the amplifier 61 and the speaker unit.

Although the general amplifying device 6 is able to transmit the voice signal, the signal transmission line 7 has to be set between the amplifier 61 and each speaker unit 63. Besides, the amplifier 61 and the microphone unit 62 are usually deposed in a guard room, a community head office or a school broadcasting room, etc., and the speaker units 63 are usually deposed against a wire pole, on a wall or at a corner of a building, etc., so that there is usually a long distance between the amplifier 61 and the speaker unit 63. Hence, the wiring of the signal transmission line 7 is complex. In addition, because the signal transmission line 7 after the wiring is exposed to the external environment, the signal transmission line 7 is apt to be damaged, hardened or broken, etc. Hence, the prior art does not fulfill users' requests on actual use.

### SUMMARY OF THE INVENTION

The main purpose of the present invention is to input a voice signal to an input device to be transmitted along an indoor electrical power to an output device by using an amplifying device coordinated with a first and a second power frequency carrier device.

To achieve the above purpose, the present invention is a broadcasting device having power frequency carrier, comprising an amplifying device, an input device and an output device, where the amplifying device comprises a first power frequency carrier device and a signal control module; the first power frequency carrier device comprises a junction to connect to an indoor electrical power; the input device is connected with the signal control module; the output device comprises a voice output unit and a second power frequency carrier device; and the second power frequency carrier device comprises a junction to connect to the indoor electrical power. Thus, a novel broadcasting device having power frequency carrier is obtained to transfer a voice signal.

### BRIEF DESCRIPTION OF DRAWINGS

The present invention will be better understood from the following detailed descriptions of the preferred embodiments according to the present invention, taken in conjunction with the accompanying drawings, in which

FIG. 1 is a fundamental structural view according to a preferred embodiment of the present invention;

FIG. 2 is a structural block view according to the preferred embodiment of the present invention;

FIG. 3 is a view showing a first state of use according the preferred embodiment of the present invention;

FIG. 4 is a view showing a second state of use according the preferred embodiment of the present invention; and

FIG. 5 is a structural view showing an amplifying device of a prior art.

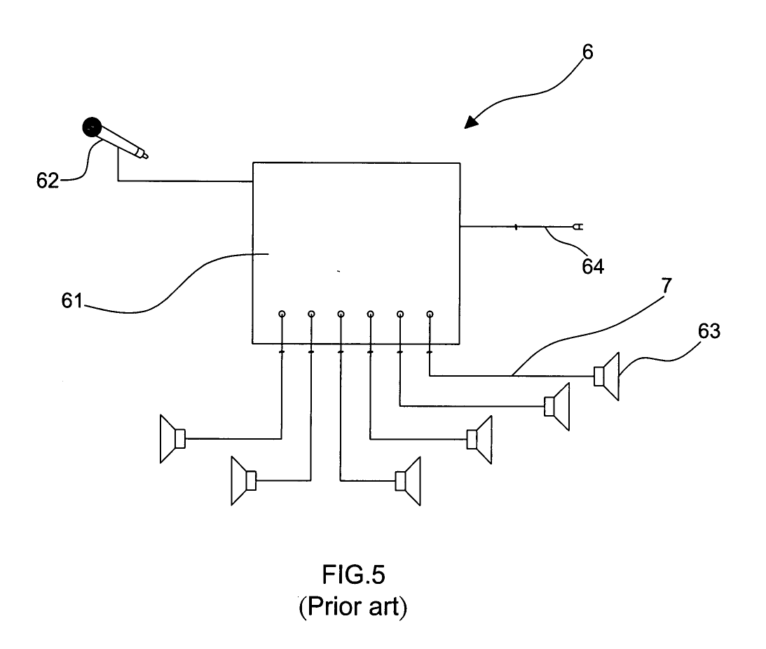

### DESCRIPTION OF THE PREFERRED EMBODIMENTS

The following descriptions of the preferred embodiments are provided to understand the features and the structures of the present invention.

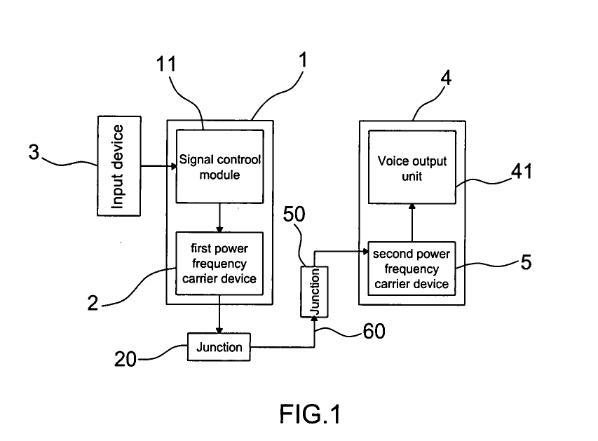

Please refer to FIG. 1, which is a fundamental structural view according to a preferred embodiment of the present invention. As shown in the figure, the present invention is a broadcasting device having power frequency carrier, comprising an amplifying device 1, an input device 3 and at least an output device 4.

The amplifying device 1 comprises a first power frequency carrier device 2 and a signal control module 11, where the signal control module 11 is connected with the first power frequency carrier device 2, and the first power frequency carrier device 2 comprises a first junction 20 to connect to an indoor electrical power line 60.

The input device 3 is connected with the signal control module 11 of the amplifying device 1, which can be a microphone.

The output device 4 comprises a voice output unit 41 and a second power frequency carrier device 5, where the second power frequency carrier device 5 is connected with the voice output unit 41 and comprises a second junction 50 to connect to the indoor electrical power line 60 to communicate a voice signal with the amplifying device 1. Thus, with the above structure, a novel broadcasting device having power frequency carrier is obtained.

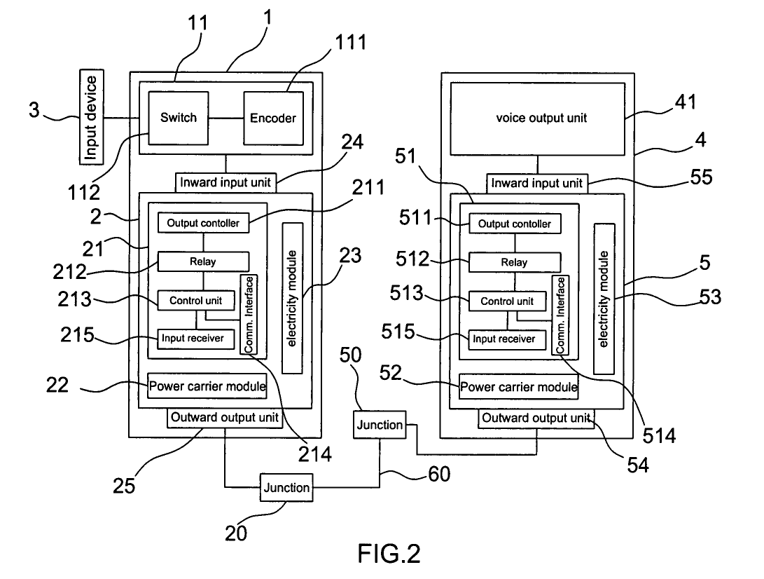

Please refer to FIG. 2, which is a structural block view according to the preferred embodiment of the present invention. As shown in the figure, a signal control module 11 comprises an encoder 111 and a switch 112.

A first power frequency carrier device 2 comprises a first single-chip control module 21 comprising a first output controller 211, a first relay 212, a first control unit 213, a first communication interface 214 and a first input receiver 215; a first power carrier module 22 having a transmission rate of 1200 BPS (bit per second); a first electricity module 23 providing required power for the first single-chip control module 21 and the first power carrier module 22; a first inward input unit 24; and a first outward output unit 25.

A second power frequency carrier device 5 of the present invention comprises a second single-chip control module 51 comprising a second output controller 511, a second relay 512, a second control unit 513, a second communication interface 514 and a second input receiver 515; a second power carrier module 52 having a transmission rate of 1200 BPS; a second electricity module 53 providing required power for the second single-chip control module 51 and the second power carrier module 52; a second inward input unit 54; and a second outward output unit 55.

Each of the first and the second control units 213,513 in the first and the second power frequency carrier device 2,5 is respectively a 8051 single-chip as a processing unit with a good inner structure, whose working frequency is up to 16 MHz together with a 4 k size of electrically programmable and erasable ROM (Read Only Memory) together with eight input pins and eight output pins. Each of the first and the second relay 212,512 is located at the output pins of the 8051 single-chip to quarantine the circuit for securing and ensuring the operation of the 8051 single-chip. Each 8051 single-chip contains a full-duplex communication interface inside, which are the first and the second communication interfaces 214,514. Each communication interface 214,514 is an RS232 interface to simultaneously transfer and receive data from outside. The operational signals in the 8051 single-chip are on a TTL (transistor-transistor-logic) level (0 voltage set as logic 0; +5 voltage set as logic 1) and each communication interface 214,514 is a serial communication interface to transfer or receive data in a form of bit series.

When using the present invention, the amplifying device 1 and the input device 3 are deposed at a required place, such as a guard room, a community head office, a school broadcasting room, etc.; and the output device 4 is deposed at another required place, such as against a wire pole, on a wall, at a corner, etc. Then, a first junction 20 of the amplifying device 1 connects to the second junction 50 of the output device 4 through an indoor electrical power line 60. Thus, the amplifying device 1, the input device 3 and the output device 4 are located in a specific area.

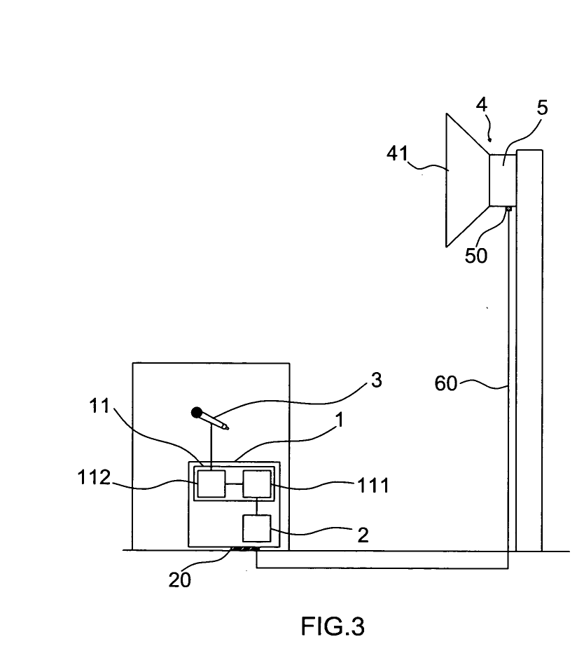

Please further refer to FIG. 3, which is a view showing a first state of use according the preferred embodiment of the present invention. As shown in the figure, when one amplifying device 1 connecting to one output device 4 is used, a user inputs a voice signal by using an input device 3. Then, the voice signal is transmitted to the first power frequency carrier device 2 from the first inward input unit 24 through the first signal control module 11. Hence, the .voice signal is encoded by the encoder 111 and is integrated with an indoor electricity by using the first single-chip control module 21, the first power carrier module 22 and the first electricity module 23. A mode and a speed for a transmission are detected and setup by the first single-chip control module 21. Then the integrated signal is transmitted by using the first outward output unit 25 of the first power frequency carrier device 2 through a first junction 20; then the voice signal is transmitted out with the indoor electricity by using the first outward output unit 25 through the first junction 20 to the second power frequency carrier device 5 of the output device 4. The second inward input unit 54 of the second power frequency carrier device 5 receives the indoor electricity and decodes the voice signal in an integrated way by using the second single-chip control module 51, the second power carrier module 52 and the second electricity module 53. In the end, the voice signal is outputted by the second outward output unit 55 to a voice output unit 41 to be sounded.

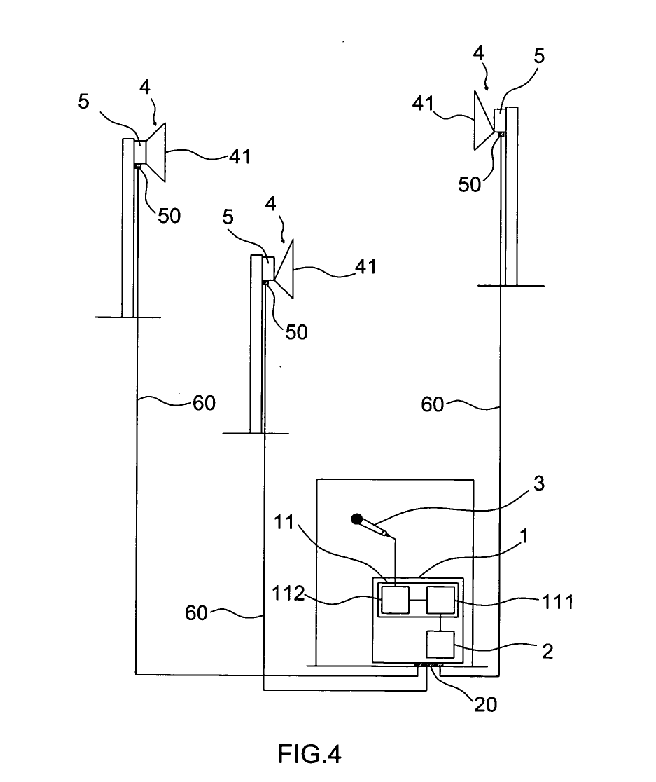

Please refer to FIG. 2 and FIG. 4, which are a structural block view and a view showing a second state of use according to the preferred embodiment of the present invention. As shown in the figures, when an amplifying device 1 connecting to a plurality of output devices 4 is used, a user switches each output device 4 on or off by a switch 112 in a signal control module 11 for the output device 4. Then, a voice signal is inputted from an input device 3 and is transmitted from an inward input unit 24 to a first power frequency carrier device 2 through the signal control module 11. Hence, the .voice signal is encoded by an encoder 111 to be integrated with an indoor electricity through a single-chip control module 21, a power carrier module 22 and an electricity module 23. A mode and a speed for a transmission are detected and setup by the single-chip control module 21. Then the integrated signal is transmitted by using an outward output unit 25 of the first power frequency carrier device 2 through a first junction 20; then the indoor electricity having the voice signal is transmitted out from the outward output unit through the first junction 20 to a second power frequency carrier device 5 of each output device 4. An inward input unit 54 of the second power frequency carrier device 5 receives the integrated signal and decodes the integrated signal in an integrated way by a second single-chip control module 51, a second power carrier module 52 and a second electricity module 53. Then the mode of a switch 12 for each signal control module 11 is detected to acquire the switching on or off of the output device. In the end, if the mode is ‘on’, the voice signal is outputted by an outward output unit 55 to a voice output unit 41 to be sounded. If ‘off’, the voice signal is omitted.

To sum up, the present invention is a broadcasting device having power frequency carrier, where a voice signal received from an input device is transmitted to at least one output device through an indoor electrical power line with the help of an amplifying device coordinated with a first and a second power frequency carrier device.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A broadcasting device having power frequency carrier, comprising
(a) an amplifying device comprising a first power frequency carrier device and a signal control module, said signal control module connected with said first power frequency carrier device, said first power frequency carrier device comprising a first junction connected with an indoor electrical power line;
(b) an input device connected with said signal control module of said amplifying device; and
(c) at least one output device comprising a voice output unit and a second power frequency carrier device, said second power frequency carrier device connected with said voice output unit, said second power frequency carrier device comprising a second junction connected with said indoor electrical power line to communicate a voice signal with said amplifying device.

2. The broadcasting device according to claim 1, wherein each of said first and said second power frequency carrier devices comprises a single-chip control module, a power carrier module, an electricity module, an outward output unit and an inward input unit.

3. The broadcasting device according to claim 2, wherein said single-chip control module comprises an input receiver, an output controller, a control unit, a communication interface and a relay.

4. The broadcasting device according to claim 2, wherein said power carrier module comprises a transmission rate of 1200 BPS (bit per second).

5. The broadcasting device according to claim 3, wherein said control unit is a 8051 single-chip.

6. The broadcasting device according to claim 3, wherein said control unit comprises a working frequency up to 16 MHz (megahertz).

7. The broadcasting device according to claim 3, wherein said communication interface is an RS232 interface.

8. The broadcasting device according to claim 1, wherein said signal control module comprises an encoder and a switch.

9. The broadcasting device according to claim 1, wherein said input device is a microphone.
